(19) United States
(12) Patent Application Publication
(10) Pub. No.: US 2023/0160972 A1
(43) Pub. Date: May 25, 2023

(54) Computer-Assisted Method for Determining a Loss Of Capacity of a Battery Store, Computer Program Product and Battery Store

(71) Applicant: Siemens Aktiengesellschaft, München (DE)

(72) Inventor: Barbara Schricker, Erlangen (DE)

(73) Assignee: Siemens Aktiengesellschaft, München (DE)

(21) Appl. No.: 17/991,922

(22) Filed: Nov. 22, 2022

(30) Foreign Application Priority Data
Nov. 23, 2021 (EP) 21209939.4

(51) Int. Cl. G01R 31/392; G01R 31/3835; G01R 31/367

(52) U.S. Cl. CPC G01R 31/392; G01R 31/3835; G01R 31/367

(57) ABSTRACT

Various embodiments of the teachings herein include a computer-assisted method for simulating a loss of capacity of a battery store. The method may include: creating a load characteristic of the battery; determining temporal characteristics of simulated operating data of the battery with the load characteristic as input data based on modelled behavior of the battery store in an ECM; analyzing the operating data, including determining minimum open-circuit voltages and maximum open-circuit voltages based on the temporal characteristics; determining open-circuit voltage differences between the minimum and the maximum open-circuit voltages and determining mean open-circuit voltages; and determining a loss of capacity of the battery store in an aging module using an aging model based on the open-circuit voltage differences and mean open-circuit voltages as input variables.

### CROSS-REFERENCE TO RELATED APPLICATIONS

This application claims priority to EP Application No. 21209939.4 filed Nov. 23, 2021, the contents of which are hereby incorporated by reference in their entirety.

### TECHNICAL FIELD

The present disclosure relates to batteries. Various embodiments of the teachings herein include computer-based methods and/or systems for determining a loss of capacity of a battery store and battery stores.

### BACKGROUND

Lithium-ion rechargeable batteries, also referred to as lithium-ion batteries below, are used as energy stores in mobile and stationary applications on account of their high power density and energy density. In order to be able to operate these electro-chemical energy stores safely, reliably and for as long as possible without maintenance, as accurate knowledge of critical operating states as possible is necessary, in particular with respect to the state of charge and with respect to the state of health.

It is known that the aging of a battery, in particular what is known as the cyclic aging, can be negatively affected in particular by high temperatures and rapid charging at low temperatures, depending on the state of charge, the depth of discharge, and the charging power and the discharge power. It is therefore possible that the same type of battery cell will have to handle a different large number of charge cycles depending on the specified parameters. For a technical design of a battery store, it is therefore necessary to estimate the lifetime of the battery store depending on the subsequent application, in particular depending on a subsequent load characteristic and/or ambient conditions.

A future aging performance determined on the basis of physical and/or chemical measurements in accordance with the load profile, the operating point and the ambient conditions, is difficult to carry out due to the non-linearity of the underlying physical and chemical processes and their complex interactions. In order to determine the expected aging performance, in the prior art measurements made prior to the design phase of a battery system are used to determine a comprehensive aging characteristic of the battery cell used. The real aging rate with real load profiles is often not tested because such tests are too time-consuming. Rather, the aging rate, or the cycle stability, is determined on compressed load profiles in so-called rafftests. These results are used to parameterize empirical aging models, which are later used to estimate the aging performance in the application.

The prediction of the aging performance of a battery is unfortunately complex. The parameterization of a meaningful aging model is often very time-consuming, which is a disadvantage. The physical or electrochemical parameters that affect aging, such as the electrode potentials, are not directly accessible to the user or battery integrator. As an alternative, accessible parameters such as the state of charge are therefore used in the aging models. In order to be able to describe the complex relationships by means of mathematical formulas, further simplifications are made. These disadvantageously make the aging models inaccurate. This has the detrimental effect that battery stores are dimensioned to be larger than the performance and lifetime requirements would actually require, in order to ensure sufficient power and thus to be able to comply with liability and warranty commitments even at the end of the designed period.

### SUMMARY

The teachings of the present disclosure include methods and/or systems which determine the aging behavior of battery stores more reliably and more accurately compared with the prior art without increasing its complexity. For example, some embodiments include a computer-assisted method for simulating a loss of capacity of a battery store, having a plurality of steps: creating a load characteristic of the battery store, determining temporal characteristics of simulated operating data of the battery store with the load characteristic as input data based on modeling of the behavior of the battery store by means of an equivalent circuit model in an ECM module (2), wherein the simulated operating data includes the open-circuit voltage (OCV), analyzing the operating data in an analysis module (3), wherein minimum open-circuit voltages and maximum open-circuit voltages are determined from the temporal characteristics of the simulated operating data, determining open-circuit voltage differences (DOCV) between the minimum open-circuit voltages and the maximum open-circuit voltages and determining mean open-circuit voltages (OCVₘₑₐₙ) in the analysis module (3), and determining the loss of capacity of the battery store in an aging module (4) on the basis of an aging model, which is based on the open-circuit voltage differences (DOCV) and mean open-circuit voltages (OCVₘₑₐₙ) as input variables.

In some embodiments, based on a modeling of the behavior of the battery store by means of an equivalent circuit model in the ECM module (2) a current (21), a C-rate (CPR), a temperature (23) and/or a number of equivalent full cycles of the battery store is determined.

In some embodiments, in the analysis module (3) a mean value of the open-circuit voltage (OCVₘₑₐₙ), the current, the temperature (Tₘₑₐₙ) and/or the proportion of equivalent full cycles is determined.

In some embodiments, the proportion of equivalent full cycles (EFC), the current, the C-rate (CPRₘₑₐₙ) and/or the temperature (Tₘₑₐₙ) are used as input variables for the aging model.

In some embodiments, the analysis of the simulated operating data in the analysis module (3) is carried out on the basis of a sliding time window or by means of a rain-flow counting method.

In some embodiments, an open-circuit voltage reference value (OCV_{ref}), a reference temperature (T_{ref}), a reference open-circuit voltage difference (DOC_{ref}) and a reference C-rate (CPR_{ref}) are used as input variables for the aging model.

In some embodiments, the aging model comprises at least one temperature term, an open-circuit voltage term, an open-circuit voltage difference term, a C-rate term and an equivalent full-cycle term.

In some embodiments, each term of the aging model comprises at least one optimization parameter, wherein the optimization parameters are determined by fitting to at least one synthetic load profile.

In some embodiments, a×e^{b×(T(t)-T}^{_{ref}}⁾ is used as the temperature term, where a and b are optimization parameters.

In some embodiments, a remaining lifetime (41) of the battery cell is determined based on the loss of capacity (40) and end-of-life parameters.

In some embodiments, in a design module a recycled battery store composed of at least two battery storage cells is simulated, wherein an optimum for a remaining lifetime (41) of the recycled battery store and/or for storage costs per energy unit in the recycled battery store is determined.

In some embodiments, based on the determined loss of capacity and the remaining lifetime of the battery store, in a design module an arrangement of the battery cells is determined which has a maximum lifetime of the battery cells.

As another example, some embodiments include a computer program product, which is able to be loaded directly into a memory of a programmable processing unit, containing program code means for carrying out one or more of the methods described herein when the computer program product is executed in the processing unit.

As another example, some embodiments include a battery store with a processing unit (1), which is configured to execute one or more of the methods described herein.

In some embodiments, the processing unit (1) is arranged locally separate from the battery store and is configured to exchange data with the battery store via remote access over a network.

### BRIEF DESCRIPTION OF THE DRAWINGS

Further features, properties, and advantages of the teachings of the present disclosure result from the description that follows with reference to the accompanying figures. In the figures, in each case schematically:

FIG. 1 shows a processing unit with an ECM module, an analysis module, and an aging module incorporating teachings of the present disclosure; and

FIG. 2 shows a method schema of a method for determining the loss of capacity of a battery store incorporating teachings of the present disclosure.

### DETAILED DESCRIPTION

The teachings of the present disclosure include computer-assisted methods for simulating a loss of capacity of a battery store. In some embodiments, a load characteristic of the battery store is created. Then, in an ECM module, temporal characteristics of simulated operating data are determined based on a modeling of the behavior of the battery store according to the load characteristic as input data by means of an equivalent circuit model, wherein the simulated operating data includes the open-circuit voltage. In an analysis module, a minimum open-circuit voltage and a maximum open-circuit voltage are determined from the temporal characteristics of the operating data. Furthermore, open-circuit voltage differences between the minimum open-circuit voltage and the maximum open-circuit voltage are determined in the analysis module. Mean open-circuit voltages are also determined in the analysis module. This is followed by determining the loss of capacity of the battery store in an aging module on the basis of an aging model, which is based on the open-circuit voltage differences and the mean open-circuit voltages as input variables.

The minimum open-circuit voltage and the maximum open-circuit voltage are determined in such a way that the temporal characteristics of the operating data are divided into sections, with the minimum and maximum open-circuit voltage within these sections being determined.

The computer program products described herein may be loaded directly into a memory of a programmable processing unit and comprises program code means for carrying out one or more of the methods described herein when the computer program product is executed in the processing unit.

In some embodiments, a battery store incorporating teachings of the present disclosure comprises a processing unit which is configured to carry out one or more of the computer-assisted methods described herein.

The load characteristic is the load or power with which the battery store is operated during a defined operating period. Operation here means both charging and discharging processes. In particular, typical load characteristics of electrically operated means of transport (motor vehicle, boat, train) or of domestic storage systems of measurement data or simulations are used.

Determining a load characteristic here means that a load characteristic is determined, in particular as a function of the future type of usage or application of the battery store and/or the future location of use (in particular climatic conditions). This can be determined in particular by measurement, by means of a load characteristic known from a simulation for an operating period, or by combining multiple individual load characteristics into one load characteristic.

In some embodiments, a battery store can be used as a traction battery in a train. Based in particular on the terrain profile, the weight of the train, the distance to the next station, the required charging speed and the speed profile of the train, the load characteristic is defined and a power and energy requirement that must be handled by the battery is determined.

In some embodiments, the battery store can be used in particular as a stationary store that is intended to temporarily store energy from renewable sources, e.g. from photovoltaic systems. The energy to be stored is determined by the power of the photovoltaic system—i.e. indirectly, via the solar radiation. The storage size is determined in particular by the size of the connected photovoltaic system and by the electrical consumers on the network. The superposition of the energy generation over time and the energy consumption over time results in the load characteristic of the battery store.

A “module” in the context of this disclosure may be understood to mean for example a processor and/or a memory unit for storing program commands. By way of example, the processor may be designed to execute the program commands such that the processor performs functions for implementing one or more of the methods described herein. Within the scope of this disclosure, it is possible that the function of individual modules may be executed either on separate processors and memory units or on shared processors and memory units.

An ECM module (ECM=equivalent circuit model) means the unit in which operating data of a battery cell of the battery store are determined by means of the equivalent circuit model. An analysis module means a unit in which the operating data that was determined in the ECM module is analyzed. An aging module means a unit in which the capacity loss of the battery store is determined based on the analyzed data by means of an aging model. A battery store means a lithium-ion rechargeable battery.

In some embodiments, the aging model includes the mean open-circuit voltage and the open-circuit voltage difference in order to determine the aging behavior of the battery store reliably and efficiently. If the open-circuit voltage data is used, neither the electrode potentials nor the depth of discharge (DOD) nor the mean state of charge (SOC) need to be included in the determination of the aging behavior, but a reliable determination of the aging is still achieved. It is possible using the methods described herein to reliably predict the aging behavior, in other words the loss of capacity, of a battery store. This allows a prediction of the loss of capacity of a particular battery store. It is then possible to avoid the need to overdimension the battery store for safety reasons.

One advantage of the use of open-circuit voltage differences and open-circuit voltages in the aging model is that these variables can be derived directly from the operating data. Furthermore, these variables describe the physical background behind the aging mechanisms better than the variables depth of discharge (DOD) and state of charge (SOC). This method therefore allows a more precise model-based calculation of aging compared to current techniques from the prior art.

In some embodiments, based on a model of the behavior of the battery cell during operation with the load characteristic using an equivalent circuit model in the ECM module, a current, a temperature, and/or a C-rate of the battery store are determined in addition to the open-circuit voltage. In the analysis module, the signals are divided into individual sections, in particular when using the rainflow counting method, and from these, mean values of the open-circuit voltage, current, temperature and/or differences are formed from the minimum and maximum values of the open-circuit voltage. The proportional equivalent full cycles are determined by integrating the current. Proportional means here that the characteristics of the period considered are divided into individual sections and for each of these sections the number of equivalent full cycles this section corresponds to is calculated. Typically, a section is a proportion of less than one equivalent full cycle.

The input variables used for the aging model are the proportional equivalent full cycles, with the corresponding open-circuit voltage differences as well as the mean values of the open-circuit voltage, the current, the C-rate and/or the temperature.

The loss of capacity is then determined in particular based on the open-circuit voltage difference, the mean open-circuit voltage and at least one of the variables of current, temperature, number of equivalent full cycles, C rate and/or their mean values. The aging behavior of the battery cell, in other words of the loss of capacity of the battery cell, is described more precisely than in the methods according to the prior art.

In some embodiments, the analysis of the simulated operating data in the analysis module is carried out on the basis of a sliding time window or by means of a rainflow counting procedure. The length of the sliding time window is adapted to the load characteristic in such a way that it is able to reflect the significant changes in the operating points.

In some embodiments, the operating period is analyzed using a rainflow counting procedure. The rainflow counting procedure is based on the detection of turning points and divides the curve into individual sections. The division of the curve into the individual sections is already fitted to the curve. This enables an additional increase in the accuracy of the determination of the capacity loss.

In some embodiments, the input variables used for the aging model are an open-circuit voltage reference value, a reference temperature, a reference open-circuit voltage difference, and a reference C-rate. This allows the aging model to be optimized, in particular the aging model to be fitted to reference states. This may make the aging model more robust.

In some embodiments, the aging model comprises at least one temperature term, an open-circuit voltage term, an open-circuit voltage difference term, a C-rate term, and an equivalent full-cycle term. The aging model thus describes the physical aging processes of the battery cell, so that the model can describe or predict the loss of capacity of the battery cell with high accuracy. In some embodiments, it is not necessary to determine the electrode potentials or the depth of discharge (DOD) for a model. By using more than one of these terms at a time, several of the mechanisms underlying the aging process can be represented in the model, which in turn can be used to enhance the accuracy of the model.

In some embodiments, each term of the aging model comprises at least one optimization parameter, wherein the optimization parameters are determined by an adaptation, in other words a fitting, to at least one synthetic load profile. A synthetic load profile is defined as a load profile that is impressed upon a battery cell in the laboratory. The synthetic load profiles are selected in such a way that the test domain used includes the typical operating points that can be expected in the subsequent application. Design of Experiment (DOE) methods are used to minimize the number of measurements required. In the laboratory, the battery store is operated with the synthetic load profile and measured operating data is generated.

In some embodiments, the temperature term used is a×e^{b×(T(t)-T}^{_{ref}}⁾, where a and b are optimization parameters. The optimization parameters in this temperature term are in the same order of magnitude as the other optimization parameters used in the model. This property makes the model more robust. A local minimum is found more efficiently. If an Arrhenius term is used according to the prior art, the optimization parameters would differ from one another by orders of magnitude.

In some embodiments, a remaining lifetime of the battery store is determined based on the loss of capacity and end-of-life parameters. End-of-life parameters are defined in this context as the remaining capacity of the battery at the end of its lifetime. This value is specified by definition when the battery is designed. In practice, this value is typically between 70% and 80% of the initial residual capacity.

In some embodiments, in a design module a recycled battery store composed of at least two battery storage cells is simulated, wherein an optimum is determined for a remaining lifetime of the recycled battery store and/or for storage costs per energy unit in the recycled battery store. It is thus possible to combine battery cells in a battery store, in particular also in Second Life applications, which have a similar aging state, thus making it possible to assemble a more reliable battery store with a lifetime that is as long as possible.

In some embodiments, the design module determines, based on the determined loss of capacity of the battery store, an arrangement of the battery cells with which the battery store is able to achieve the planned lifetime of the battery cells without having to over-dimension the store.

In some embodiments, the processing unit is arranged locally separate from the battery store and is configured to exchange data with the battery store remotely over a network. Advantageously, it is therefore also possible to analyze an aging condition remotely.

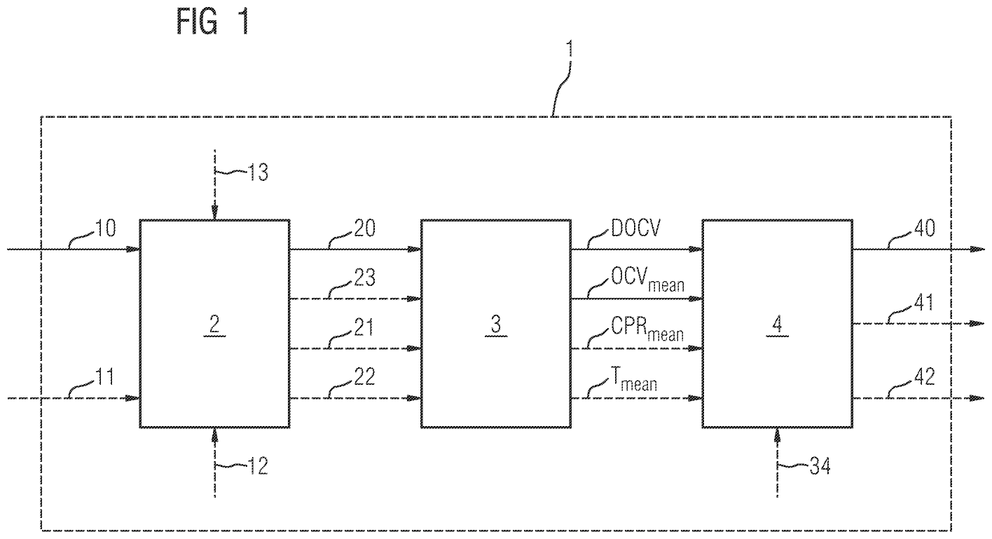

FIG. 1 shows an example processing unit 1 with an ECM module 2, an analysis module 3, and an aging module 4. Depending on the application of the battery store, a defined load characteristic 10 is fed into the ECM module 2 as an input variable. Ambient conditions 11 can also be fed into the ECM module 2 as an input variable. In the ECM module 2, the battery store is simulated by means of an equivalent circuit model. The ECM module 2 receives configuration values 12 for the equivalent circuit model. In addition, the ECM module 2 can be supplied with starting values 13 for modeling the battery store using an equivalent circuit model.

In the ECM module, the operating data of a battery cell of the battery store associated with a load characteristic is simulated by means of the equivalent circuit model. The operation of the battery store is modeled according to the load characteristics supplied to the model. The simulated operating data includes the open-circuit voltage 20. The determined open-circuit voltage 20 as well as, for example, the current 21, an operating voltage 22, and an operating temperature 23 are transmitted to the analysis module 3. In the analysis module 3, the temporal characteristic of the signals, in particular that of the open-circuit voltage OCV, is analyzed. Minimum open-circuit voltages and maximum open-circuit voltages are determined. Based on these, open-circuit voltage differences DOCV between the minimum open-circuit voltage and the maximum open-circuit voltage and mean open-circuit voltages OCVₘₑₐₙ are analyzed in the analysis module 3. Mean C-rates CPRₘₑₐₙ or mean temperatures Tₘₑₐₙ and proportional equivalent full cycles can also be determined in the analysis module 3. The open-circuit voltage differences DOCV, the mean open-circuit voltages OCVₘₑₐₙ as well as the mean temperatures Tₘₑₐₙ and the mean C-rates CPRₘₑₐₙ determined in the analysis module 3 are transferred to the aging module 4 together with the proportional equivalent full cycles EFC.

In the aging module 4, the loss of capacity of a battery store is determined by means of an aging model, wherein the aging model is based on the open-circuit voltage difference DOCV and the mean open-circuit voltage OCVₘₑₐₙ as input variables.

The model equation and the associated model parameters are fed to the aging module. Model equation and model parameters are determined in advance based on laboratory measurements. In some embodiments, the model parameters could also be determined in the aging module itself. In this case, processed measurement data from the laboratory measurements would need to be supplied to the aging module.

As an example, equation 1 shows a modeling approach that describes the capacitance loss 40 (c(t)/c(t=0) as a function of the “equivalent full cycles” EFC based on the open-circuit voltage difference DOCV and the mean open-circuit voltage OCVₘₑₐₙ. For increased reliability of the calculation, the temperature T, C-rate CPR and the number of equivalent full cycles EFC are also included in the determination of the aging in the aging module 4. A reference open-circuit voltage OCV_{ref}, a reference temperature T_{ref} and a reference open-circuit voltage difference DOCV_{ref} are also used.

$$\frac{c ( EFC ( t ) )}{c ( EFC ( t = 0 ) )} = 1 - {10}^{- 3} ⨯ {a}_{2} ⨯ {e}^{t 2 ⨯ ( T - {T}_{ref} )} ⨯ {e}^{s 2 ⨯ ( {OCV}_{mean} - {OCV}_{ref} )} ⨯ {e}^{d 2 ⨯ ( {D}_{OCV} - {D}_{{OCV}_{ref}} )} ⨯ {e}^{i 2 ⨯ ( CPR - {CPR}_{ref} )} ⨯ {EFC}^{β2} - {10}^{- 3} ⨯ {a}_{3} ⨯ {e}^{t 3 ⨯ ( T - {T}_{ref} )} ⨯ {EFC}^{β2} \qquad ( 1 )$$

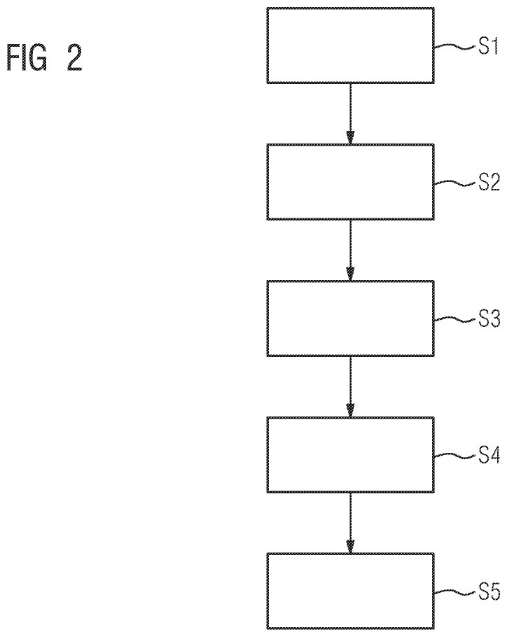

FIG. 2 shows a method schema of the method for determining a loss of capacity of a battery store incorporating teachings of the present disclosure. In a first step S1, a load characteristic of a battery store is determined. In a second step S2 the temporal characteristics of simulated operating data of the battery store are determined according to the load characteristic. The determination is based on a model of the behavior of the battery cell by means of an equivalent circuit model in an ECM module 2. The operating data includes the open-circuit voltage OCV. In a third step S3, the analysis of the operating data is carried out in an analysis module 3. The analysis module 3 also determines minimum open-circuit voltages and maximum open-circuit voltages and mean open-circuit voltages OCVₘₑₐₙ. In a fourth step S4, an open-circuit voltage difference DOCV is then determined between the minimum open-circuit voltages and maximum open-circuit voltages. In a fifth step S5 the loss of capacity of the battery store is determined in an aging module 4 on the basis of an aging model, which is based on the open-circuit voltage difference DOCV and the mean open-circuit voltage OCVₘₑₐₙ as input variables. The loss of capacity is particularly advantageously determined by means of the aging model according to equation 1.

Although the teachings of the present disclosure have been described and illustrated in greater detail by means of the exemplary embodiment, the scope of the disclosure is not limited by the disclosed examples. Variations thereof can be derived by a person skilled in the art without departing from the scope of protection as defined by the patent claims which follow.

### LIST OF REFERENCE SIGNS

1 processing unit
2 ECM module
3 analysis module
4 aging module
10 load characteristic
11 environmental conditions
12 configuration values
13 starting values
20 open-circuit voltage
21 current
22 voltage
23 temperature
33 mean temperature
34 model parameters
40 loss of capacity
41 lifetime
42 cost per unit of energy stored
S1 determining a load characteristic of a battery store
S2 determining operating data of a battery cell
S3 analyzing the operational data in an analysis module
S4 determining an open-circuit voltage difference and a mean open-circuit voltage in the analysis module
S5 determining the capacity loss of a battery cell in an aging module
OCV open-circuit voltage
OCVₘₑₐₙ mean open-circuit voltage
DOCV open-circuit voltage difference
CPRₘₑₐₙ mean C-rate

1. A computer-assisted method for simulating a loss of capacity of a battery store, the method comprising:
creating a load characteristic of the battery store;
determining temporal characteristics of simulated operating data of the battery store with the load characteristic as input data based on modeling of behavior of the battery store using an equivalent circuit model in an ECM module, wherein the simulated operating data includes an open-circuit voltage;
analyzing the operating data in an analysis module, including determining minimum open-circuit voltages and maximum open-circuit voltages based on the temporal characteristics of the simulated operating data;
determining open-circuit voltage differences between the minimum open-circuit voltages and the maximum open-circuit voltages and determining mean open-circuit voltages in the analysis module; and
determining a loss of capacity of the battery store in an aging module using an aging model based on the open-circuit voltage differences and mean open-circuit voltages as input variables.

2. The computer-assisted method as claimed in claim 1, further comprising determining with the ECM module a current, a C-rate, a temperature, and/or a number of equivalent full cycles of the battery store based on an equivalent circuit model showing behavior of the battery store.

3. The computer-assisted method as claimed in claim 2, further comprising determining a mean value of the open-circuit voltage, the current, the temperature, and/or the proportion of equivalent full cycles using the analysis module.

4. The computer-assisted method as claimed in claim 1, wherein input variables to the aging model include a proportion of equivalent full cycles, a current, the C-rate, and/or the temperature.

5. The computer-assisted method as claimed in claim 1, wherein the analysis of the simulated operating data includes using a sliding time window or a rain-flow counting method.

6. The computer-assisted method as claimed in claim 1, wherein input variable to the aging model include an open-circuit voltage reference value, a reference temperature, a reference open-circuit voltage difference, and a reference C-rate.

7. The computer-assisted method as claimed in claim 1, wherein the aging model includes at least one of: a temperature term, an open-circuit voltage term, an open-circuit voltage difference term, a C-rate term, or an equivalent full-cycle term.

8. The computer-assisted method as claimed in claim 7, wherein each term of the aging model comprises at least one optimization parameter, and the optimization parameters are determined by fitting to at least one synthetic load profile.

9. The computer-assisted method as claimed in claim 7, wherein the temperature term is a×e^{b×(T(t)-T}^{_{ref}}⁾, wherein a and b are optimization parameters.

10. The computer-assisted method as claimed in claim 1, further comprising determining a remaining lifetime of the battery cell based on the loss of capacity and end-of-life parameters.

11. The computer-assisted method as claimed in claim 1, further comprising simulating in a design module a recycled battery store composed of at least two battery storage cells;
wherein the simulation provides an optimum for a remaining lifetime of the recycled battery store and/or for storage costs per energy unit in the recycled battery store.

12. The computer-assisted method as claimed in claim 10, further comprising determining, based on the determined loss of capacity and the remaining lifetime of the battery store, in a design module an arrangement of the battery cells which provides a maximum lifetime of the battery cells.

13. A computer program product, which is able to be loaded directly into a memory of a programmable processing unit, containing program code causing the processing unit to:
create a load characteristic of the battery store;
determine temporal characteristics of simulated operating data of the battery store with the load characteristic as input data based on modeling of behavior of the battery store using an equivalent circuit model in an ECM module, wherein the simulated operating data includes an open-circuit voltage;
analyze the operating data in an analysis module, including determining minimum open-circuit voltages and maximum open-circuit voltages based on the temporal characteristics of the simulated operating data;
determine open-circuit voltage differences between the minimum open-circuit voltages and the maximum open-circuit voltages and determining mean open-circuit voltages in the analysis module; and
determine a loss of capacity of the battery store in an aging module using an aging model based on the open-circuit voltage differences and mean open-circuit voltages as input variables.

14. A battery store comprising:
at least one battery cell;
a memory storing a set of instructions; and
a programmable processing unit;
wherein the set of instructions includes program code causing the processing unit to:
create a load characteristic of the battery store;
determine temporal characteristics of simulated operating data of the battery store with the load characteristic as input data based on modeling of behavior of the battery store using an equivalent circuit model in an ECM module, wherein the simulated operating data includes an open-circuit voltage;
analyze the operating data in an analysis module, including determining minimum open-circuit voltages and maximum open-circuit voltages based on the temporal characteristics of the simulated operating data;
determine open-circuit voltage differences between the minimum open-circuit voltages and the maximum open-circuit voltages and determining mean open-circuit voltages in the analysis module; and
determine a loss of capacity of the battery store in an aging module using an aging model based on the open-circuit voltage differences and mean open-circuit voltages as input variables and
a processing unit configured to execute a method as claimed in claim 1.

15. The battery store as claimed in claim 14, wherein the processing unit is arranged separate from the at least one battery cell and is configured to exchange data with the battery store via remote access over a network.
